(19) United States
(12) Patent Application Publication
(10) Pub. No.: US 2026/0099032 A1
(43) Pub. Date: Apr. 9, 2026

(54) OPTICAL IMAGING SYSTEM

(71) Applicant: Samsung Electro-Mechanics Co., Ltd., Suwon-si (KR)

(72) Inventors: Ji Su LEE, Suwon-si (KR); Jae Hyuk HUH, Suwon-si (KR); Yong Joo JO, Suwon-si (KR)

(73) Assignee: Samsung Electro-Mechanics Co., Ltd., Suwon-si (KR)

(21) Appl. No.: 19/215,836

(22) Filed: May 22, 2025

(30) Foreign Application Priority Data
Oct. 7, 2024 (KR) 10-2024-0135644
Oct. 31, 2024 (KR) 10-2024-0152808

(51) Int. Cl. G02B 9/64; G02B 13/00

(52) U.S. Cl. CPC G02B 9/64; G02B 13/0045; G02B 13/006

(57) ABSTRACT

An optical imaging system includes a first lens, a second lens, a third lens, a fourth lens, a fifth lens, a sixth lens, a seventh lens, an eighth lens, and a ninth lens sequentially disposed from an object side, wherein a composite focal length of the first lens and the second lens has a positive value, wherein a composite focal length of the eighth lens and the ninth lens has a negative value, wherein the eighth lens and the ninth lens are cemented to each other, and wherein the optical imaging system satisfies the following conditional expression:

$$0.05 < CT 9 / CT 8 < 0.5 ,$$

where CT9 is a thickness on an optical axis of the ninth lens, and CT8 is a thickness on an optical axis of the eighth lens.

### CROSS-REFERENCE TO RELATED APPLICATIONS

This application claims the benefit under 35 USC 119(a) of Korean Patent Application Nos. 10-2024-0135644 filed on Oct. 7, 2024, and 10-2024-0152808 filed on Oct. 31, 2024, in the Korean Intellectual Property Office, the entire disclosures of which are incorporated herein by reference for all purposes.

### BACKGROUND

### 1. Field

The present disclosure relates to an optical imaging system.

### 2. Description of the Background

Recent portable terminals are equipped with cameras including an optical imaging system comprising a plurality of lenses to enable video calls and image capturing.

Furthermore, as the functionality of cameras in portable terminals gradually increases, demand for cameras for portable terminals, having high resolution, is growing.

In addition, as portable terminals are gradually becoming smaller, cameras for portable terminals are also required to be slimmer, so the development of an optical imaging system that is slim yet capable of realizing high resolution is required.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens, a second lens, a third lens, a fourth lens, a fifth lens, a sixth lens, a seventh lens, an eighth lens, and a ninth lens, sequentially disposed from an object side, wherein a composite focal length of the first lens and the second lens has a positive value, a composite focal length of the eighth lens and the ninth lens has a negative value, the eighth lens and the ninth lens are cemented to each other, and wherein the optical imaging system satisfies the following conditional expression:

$$0.05 < CT 9 / CT 8 < 0.5 ,$$

where CT9 is a thickness on an optical axis of the ninth lens, and CT8 is a thickness on an optical axis of the eighth lens.

The following conditional expression may be satisfied: 0<|f8/v8−f9/v9|<2, where f8 is a focal length of the eighth lens, v8 is an Abbe number of the eighth lens, f9 is a focal length of the ninth lens, and v9 is an Abbe number of the ninth lens.

An image-side surface of the eighth lens and an object-side surface of the ninth lens may be cemented to each other, and the image-side surface of the eighth lens and the object-side surface of the ninth lens may each have an inflection point.

The following conditional expression may be satisfied: 0.5<ave(v8, v9)/v7<1.2, where ave(v8, v9) is the average of an Abbe number of the eighth lens and an Abbe number of the ninth lens, and v7 is an Abbe number of the seventh lens.

The first lens and the second lens may be cemented to each other.

The following conditional expression may be satisfied: 0<|f1/v1−f2/v2|<2, where f1 is a focal length of the first lens, v1 is an Abbe number of the first lens, f2 is a focal length of the second lens, and v2 is an Abbe number of the second lens.

The following conditional expression may be satisfied: 0.05<CT1/CT2<0.3, where CT1 is a thickness on an optical axis of the first lens, and CT2 is a thickness on an optical axis of the second lens.

The following conditional expression may be satisfied: 1.7<ave(v1, v2)/v3<2.1, where ave(v1, v2) is the average of an Abbe number of the first lens and an Abbe number of the second lens, and v3 is an Abbe number of the third lens.

The following conditional expression may be satisfied: 3<f1/f2<4.5, where f1 is a focal length of the first lens, and f2 is a focal length of the second lens.

The following conditional expression may be satisfied: 0.4<TTL/(2×IMG HT)<0.65, where TTL is a distance on an optical axis from an object-side surface of the first lens to an imaging plane, and IMG HT is half the diagonal length of the imaging plane.

The following conditional expression may be satisfied: 0.7<f12/f<1, where f12 is the composite focal length of the first lens and the second lens, and f is a total focal length of the optical imaging system.

The following conditional expression may be satisfied: −3<f3/f<0, where f3 is a focal length of the third lens, and f is a total focal length of the optical imaging system.

The following conditional expression may be satisfied: 1.1<f7/f<1.4, where f7 is a focal length of the seventh lens, and f is a total focal length of the optical imaging system.

The following conditional expression may be satisfied: −1<f89/f<−0.5, where f89 is the composite focal length of the eighth lens and the ninth lens, and f is a total focal length of the optical imaging system.

The seventh lens may have positive refractive power, and the eighth lens and ninth lens may each have negative refractive power.

The first lens and second lens may each have positive refractive power, and the third lens may have negative refractive power.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a diagram illustrating aberration characteristics of the optical imaging system illustrated in FIG. 1.

FIG. 3 is a configuration diagram of an optical imaging system according to a second embodiment of the present disclosure.

FIG. 4 is a diagram illustrating aberration characteristics of the optical imaging system illustrated in FIG. 3.

FIG. 5 is a configuration diagram of an optical imaging system according to a third embodiment of the present disclosure.

FIG. 6 is a diagram illustrating aberration characteristics of the optical imaging system illustrated in FIG. 5.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide an optical imaging system having high resolution while being slim.

In a lens configuration diagram as described below, a thickness, a size, and a shape of a lens may be somewhat exaggerated for ease of explanation, in particular, a spherical or aspherical shape illustrated in the lens configuration diagram may be illustrated as an example, but is not limited thereto.

An optical imaging system according to an embodiment of the present disclosure may include nine lenses.

The first lens refers to the lens closest to an object side, and the ninth lens refers to the lens closest to an imaging plane (or an image sensor).

Additionally, in the present specification, values for a radius of curvature, a thickness, a distance, a focal length, or the like of a lens are all in millimeters (mm), and the unit of a field-of-view (FOV) is a degree (°).

In addition, in the description of a shape of each lens, a configuration in which one surface is convex means that a paraxial region of the one surface is convex, and a configuration in which one surface is concave means that a paraxial region of the one surface is concave.

Therefore, even if one surface of a lens is described as having a convex shape, an edge portion of the lens may be concave. Likewise, even if one surface of a lens is described as having a concave shape, an edge portion of the lens may be convex.

Meanwhile, the paraxial region refers to a very narrow region near an optical axis.

The imaging plane may refer to a virtual plane on which focus is formed by the optical imaging system. Alternatively, the imaging plane may refer to one surface of the image sensor receiving light.

An optical imaging system according to an embodiment of the present disclosure may include at least nine lenses.

For example, an optical imaging system according to an embodiment of the present disclosure may include a first lens, a second lens, a third lens, a fourth lens, a fifth lens, a sixth lens, a seventh lens, an eighth lens, and a ninth lens, sequentially disposed from an object side. At least two of the first to ninth lenses may be provided in cemented form. The other lenses may be spaced apart from each other, respectively, by preset distances along an optical axis.

An optical imaging system according to an embodiment of the present disclosure may further include an image sensor for converting an incident image of a subject into an electrical signal.

Additionally, the optical imaging system may further include an infrared filter (hereinafter referred to as a ‘filter’) to block infrared rays. The filter may be disposed between the ninth lens and the image sensor.

Additionally, the optical imaging system may further include a stop for controlling an amount of light.

The first to ninth lenses constituting an optical imaging system according to an embodiment of the present disclosure may be formed of a plastic material.

In addition, at least one lens among the first to ninth lenses may have an aspherical surface. For example, the first to ninth lenses may each have at least one aspherical surface.

That is, at least one of an object-side surface and an image-side surface of the first to ninth lenses may be aspherical. For example, both an object-side surface and an image-side surface of the first to ninth lenses may be aspherical. In this case, the aspherical surfaces of the first to ninth lenses are expressed by Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad [ Equation 1 ]$$

In Equation 1, c is a curvature (reciprocal of a radius of curvature) of a lens, K is a conic constant, and Y represents a distance from a certain point on an aspherical surface of the lens to an optical axis. In addition, the constants A˜H, J, and L˜P refer to an aspheric coefficient. Additionally, Z (SAG) represents a distance in an optical axis direction between the certain point on the aspherical surface of the lens and a vertex of the aspherical surface.

An optical imaging system according to an embodiment of the present disclosure may satisfy at least one of the conditional expressions below.

In an embodiment, the optical imaging system may satisfy the condition 0<|f1/v1−f2/v2| <2. In this case, f1 is a focal length of the first lens, v1 is an Abbe number of the first lens, f2 is a focal length of the second lens, and v2 is an Abbe number of the second lens. Therefore, chromatic aberration may be reduced.

In an embodiment, the optical imaging system may satisfy the condition 0<|f8/v8−f9/v9| <2. In this case, f8 is a focal length of the eighth lens, v8 is an Abbe number of the eighth lens, f9 is a focal length of the ninth lens, and v9 is an Abbe number of the ninth lens. Therefore, chromatic aberration may be reduced.

In an embodiment, the optical imaging system may satisfy the condition 0.05<CT1/CT2<0.3. In this case, CT1 is a thickness on an optical axis of the first lens, and CT2 is a thickness on an optical axis of the second lens. Therefore, the optical imaging system may be miniaturized while improving the image resolution.

In an embodiment, the optical imaging system may satisfy the condition 0.05<CT9/CT8<0.5. In this case, CT9 is a thickness on an optical axis of the ninth lens, and CT8 is a thickness on an optical axis of the eighth lens. Therefore, the optical imaging system may be miniaturized while improving the image resolution.

In an embodiment, the optical imaging system may satisfy the condition 0.4<TTL/(2×IMG HT)<0.65. In this case, TTL is a distance on an optical axis from an object side of the first lens to an imaging plane, and IMG HT is half the diagonal length of the imaging plane. Therefore, the optical imaging system may be miniaturized while improving the image resolution.

In an embodiment, the optical imaging system may satisfy the condition 1<f/EPD<3. In this case, f is a total focal length of the optical imaging system and EPD is a diameter of an entrance pupil of the optical imaging system. Additionally, f/EPD may refer to an F-number of the optical imaging system. Therefore, image brightness and resolution may be improved.

In an embodiment, the optical imaging system may satisfy the condition 0.7<f12/f<1. In this case, f12 is a composite focal length of the first lens and the second lens. Therefore, the resolution may be improved by appropriately adjusting refractive power of the first lens and the second lens.

In an embodiment, the optical imaging system may satisfy the condition −3<f3/f<0. In this case, f3 is a focal length of the third lens. Therefore, the occurrence of aberration may be minimized by appropriately adjusting refractive power of the third lens.

In an embodiment, the optical imaging system may satisfy the condition 3.5<|f4/f|<6. In this case, f4 is a focal length of the fourth lens. Therefore, the occurrence of aberration may be minimized by appropriately adjusting refractive power of the fourth lens.

In an embodiment, the optical imaging system may satisfy the condition 3<f5/f|<7. In this case, f5 is a focal length of the fifth lens. Therefore, the occurrence of aberration may be minimized by appropriately adjusting refractive power of the fifth lens.

In an embodiment, the optical imaging system may satisfy the condition 6<|f6/f|<15. In this case, f6 is a focal length of the sixth lens. Therefore, the occurrence of aberration may be minimized by appropriately adjusting refractive power of the sixth lens.

In an embodiment, the optical imaging system may satisfy the condition 1.1<f7/f<1.4. In this case, f7 is a focal length of the seventh lens. Therefore, the image resolution may be improved and a field curvature phenomenon may be reduced.

In an embodiment, the optical imaging system may satisfy the condition −1<f89/f<−0.5. In this case, f89 is a composite focal length of the eighth lens and the ninth lens. Therefore, the image resolution may be improved and the field curvature phenomenon may be reduced.

In an embodiment, the optical imaging system may satisfy the condition 75°<FOV×(IMG HT/f)<90°. In this case, FOV is a field of view of the optical imaging system.

In an embodiment, the optical imaging system may satisfy the condition 1.7<ave(v1, v2)/v3<2.1. In this case, ave(v1, v2) is the average of an Abbe number of the first lens and an Abbe number of the second lens, and v3 is an Abbe number of the third lens. Therefore, chromatic aberration may be reduced.

In an embodiment, the optical imaging system may satisfy the condition 0.5<ave(v8, v9)/v7<1.2. In this case, ave(v8, v9) is the average of an Abbe number of the eighth lens and an Abbe number of the ninth lens, and v7 is an Abbe number of the seventh lens. Therefore, chromatic aberration may be reduced.

In an embodiment, the optical imaging system may satisfy the condition 3<f1/f2<4.5. Therefore, the resolution may be improved by appropriately adjusting refractive power of the first lens and the second lens.

The first lens may have positive refractive power. Additionally, the first lens may have a meniscus shape convex toward an object side. For example, an object-side surface of the first lens may be convex in the paraxial region, and an image-side surface of the first lens may be concave in the paraxial region.

The second lens may have positive refractive power. Additionally, the second lens may have a meniscus shape convex toward an object side. For example, the second lens may have a convex object-side surface in the paraxial region, and an image-side surface of the second lens may be concave in the paraxial region.

The composite focal length of the first lens and the second lens may have a positive value.

The third lens may have negative refractive power. Additionally, the third lens may have a meniscus shape convex toward an object side. For example, the third lens may have a convex object-side surface in the paraxial region, and an image-side surface of the third lens may be concave in the paraxial region.

The fourth lens may have positive or negative refractive power. Additionally, the fourth lens may have a shape in which both surfaces thereof are convex. For example, an object-side surface and an image-side surface of the fourth lens may be convex in the paraxial region.

Alternatively, the fourth lens may have a meniscus shape convex toward an object side. For example, the object-side surface of the fourth lens may be convex, and the image-side surface of the fourth lens may be concave in the paraxial region.

The fifth lens may have positive or negative refractive power. Additionally, the fifth lens may have a shape in which both surfaces thereof are concave. For example, an object-side surface and an image-side surface of the fifth lens may be concave in the paraxial region.

Alternatively, the fifth lens may have a shape in which both surfaces thereof are convex. For example, the object-side surface and the image-side surface of the fifth lens may be convex in the paraxial region.

Alternatively, the fifth lens may have a meniscus shape convex toward an image side. For example, the object-side surface of the fifth lens may be concave in the paraxial region, and the image-side surface of the fifth lens may be convex in the paraxial region.

The sixth lens may have positive or negative refractive power. Additionally, the sixth lens may have a meniscus shape convex toward an object side. For example, an object-side surface of the sixth lens may be convex in the paraxial region, and an image-side surface of the sixth lens may be concave in the paraxial region.

The seventh lens may have positive refractive power. Alternatively, the seventh lens may have a meniscus shape convex toward an object side. For example, an object-side surface of the seventh lens may be convex in the paraxial region, and an image-side surface of the seventh lens may be concave in the paraxial region.

Additionally, the seventh lens may have a shape in which both surfaces thereof are convex. For example, the object-side surface and the image-side surface of the seventh lens may be convex in the paraxial region.

The eighth lens may have negative refractive power. Additionally, the eighth lens may have a meniscus shape convex toward an object side. For example, an object-side surface of the eighth lens may be convex in the paraxial region, and an image-side surface of the eighth lens may be concave in the paraxial region.

Alternatively, the eighth lens may have a shape in which both surfaces thereof are concave. For example, the object-side surface and the image-side surface of the eighth lens may be concave in the paraxial region.

The ninth lens may have negative refractive power. Additionally, the ninth lens may have a meniscus shape convex toward an object side. For example, an object-side surface of the ninth lens may be convex in the paraxial region, and an image-side surface of the ninth lens may be concave in the paraxial region.

A composite focal length of the eighth lens and the ninth lens may have a negative value.

One or more lens among the seventh to ninth lenses may have at least one inflection point formed on at least one of the object-side surface and the image-side surface. For example, the object-side surface of the seventh lens may be convex in the paraxial region and concave in a portion other than the paraxial region.

Meanwhile, among a plurality of lenses of the optical imaging system, at least two lenses may be in cemented form.

In an embodiment, among the first to ninth lenses, the two lenses disposed closest to an object side may be configured in cemented form, and the two lenses disposed closest to an image side may also be configured in cemented form.

In an embodiment, the first lens and the second lens may be in cemented form. For example, an image-side surface of the first lens and an object-side surface of the second lens may be in direct contact with each other. That is, no additional adhesive may be provided between the image-side surface of the first lens and the object-side surface of the second lens.

In an embodiment, cementing of the first lens and the second lens may be formed by applying a liquid polymer to the object-side surface of the second lens and curing the liquid polymer (e.g., UV curing). Therefore, the cured polymer may function as the first lens.

The first lens may have a relatively thin thickness compared to the second lens. Therefore, the performance of the optical imaging system may be improved by adding lenses without significantly changing a total track length of the optical imaging system.

In an embodiment, the eighth lens and the ninth lens may be in cemented form. For example, an image-side surface of the eighth lens and an object-side surface of the ninth lens may be in direct contact with each other. That is, no additional adhesive is provided between the image-side surface of the eighth lens and the object-side surface of the ninth lens.

In an embodiment, cementing of the eighth lens and the ninth lens may be formed by applying a liquid polymer to the image-side surface of the eighth lens and curing it (e.g., UV curing). Therefore, the cured polymer may function as the ninth lens.

The ninth lens may have a relatively thin thickness compared to the eighth lens. Therefore, the performance of the optical imaging system may be improved by adding lenses without significantly changing a total track length of the optical imaging system.

In an embodiment, the image-side surface of the eighth lens and the object-side surface of the ninth lens may each have an inflection point. That is, an inflection point may be at a cemented surface where the eighth lens and the ninth lens are cemented to each other.

The optical imaging system may be configured to have a field of view greater than 80°. In an embodiment, a field of view of the optical imaging system may be less than 90°.

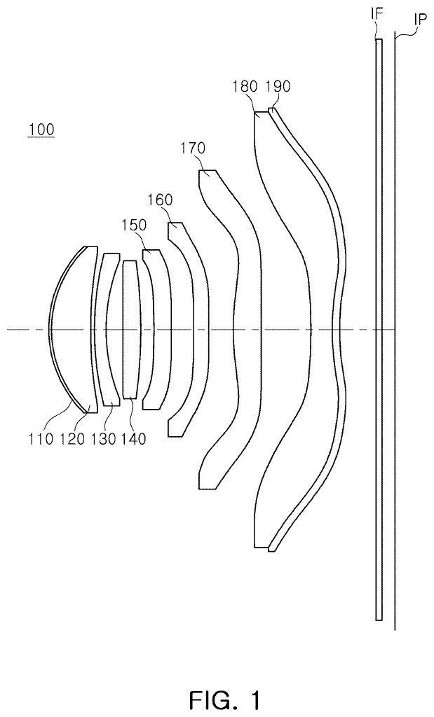

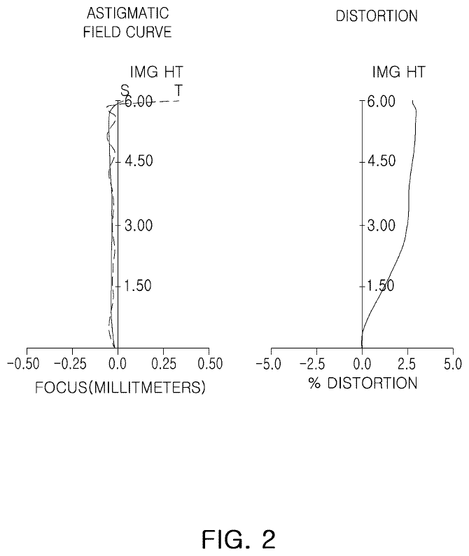

An optical imaging system 100 according to a first embodiment of the present disclosure will be described with reference to FIGS. 1 and 2.

The optical imaging system 100 according to the first embodiment of the present disclosure may include a first lens 110, a second lens 120, a third lens 130, a fourth lens 140, a fifth lens 150, a sixth lens 160, a seventh lens 170, an eighth lens 180, and a ninth lens 190 and may further include a filter IF and an image sensor.

The optical imaging system 100 according to the first embodiment of the present disclosure may form a focus on an imaging plane IP.

Lens characteristics of each lens (a radius of curvature, a thickness of a lens or a distance between lenses, a refractive index, and an Abbe number), are illustrated in Table 1.

TABLE 1

| Surface | | Curvature | Thickness or | Refractive | |
|---|---|---|---|---|---|
| No. | | Radius | Distance | Index | Abbe No. |
| S1 | 1st Lens | 2.357 | 0.052 | 1.650 | 21.0 |
| S2 | | 2.776 | 0.000 | | |
| S3 | 2nd Lens | 2.776 | 0.801 | 1.544 | 56.0 |
| S4 | | 11.105 | 0.100 | | |
| S5 | 3rd Lens | 15.053 | 0.230 | 1.671 | 19.2 |
| S6 | | 5.509 | 0.332 | | |
| S7 | 4th Lens | 26.322 | 0.355 | 1.544 | 56.0 |
| S8 | | −67.369 | 0.269 | | |
| S9 | 5th Lens | −62.139 | 0.357 | 1.671 | 19.2 |
| S10 | | 50.981 | 0.450 | | |
| S11 | 6th Lens | 30.395 | 0.310 | 1.614 | 25.9 |
| S12 | | 14.258 | 0.502 | | |
| S13 | 7th Lens | 4.529 | 0.562 | 1.567 | 37.4 |
| S14 | | 114.664 | 1.004 | | |
| S15 | 8th Lens | 10.158 | 0.443 | 1.535 | 55.7 |
| S16 | | 3.989 | 0.000 | | |
| S17 | 9th Lens | 3.989 | 0.098 | 1.650 | 21.0 |
| S18 | | 2.391 | 0.800 | | |
| S19 | Filter | Infinity | 0.110 | 1.517 | 64.2 |
| S20 | | Infinity | 0.267 | | |
| S21 | Imaging | Infinity | | | |
| | Plane | | | | |

In the first embodiment of the present disclosure, the first lens 110 may have positive refractive power, an object-side surface of the first lens 110 may be convex in the paraxial region, and an image-side surface of the first lens 110 may be concave in the paraxial region.

The second lens 120 may have positive refractive power, an object-side surface of the second lens 120 may be convex in the paraxial region, and an image-side surface of the second lens 120 may be concave in the paraxial region.

The first lens 110 and the second lens 120 may be in cemented form. For example, the image-side surface of the first lens 110 and the object-side surface of the second lens 120 may be cemented to each other.

The first lens 110 and the second lens 120 may be cemented to each other by using an adhesive.

The third lens 130 may have negative refractive power, an object-side surface of the third lens 130 may be convex in the paraxial region, and an image-side surface of the third lens 130 may be concave in the paraxial region.

The fourth lens 140 may have positive refractive power, and both an object-side surface and an image-side surface of the fourth lens 140 may be convex in the paraxial region.

The fifth lens 150 may have negative refractive power, and both an object-side surface and an image-side surface of the fifth lens 150 may be concave in the paraxial region.

The sixth lens 160 may have negative refractive power, an object-side surface of the sixth lens 160 may be convex in the paraxial region, and an image-side surface of the sixth lens 160 may be concave in the paraxial region.

The seventh lens 170 may have positive refractive power, an object-side surface of the seventh lens 170 may be convex in the paraxial region and an image-side surface of the seventh lens 170 may be concave in the paraxial region.

The eighth lens 180 may have negative refractive power, an object-side surface of the eighth lens 180 may be convex in the paraxial region, and an image-side surface of the eighth lens 180 may be concave in the paraxial region.

The ninth lens 190 may have negative refractive power, an object-side surface of the ninth lens 190 may be convex in the paraxial region, and an image-side surface of the ninth lens 190 may be concave in the paraxial region.

The eighth lens 180 and the ninth lens 190 may be in cemented form. For example, the image-side surface of the eighth lens 180 and the object-side surface of the ninth lens 190 may be cemented to each other.

The eighth lens 180 and the ninth lens 190 may be cemented to each other by using an adhesive.

One or more of the seventh lens 170 to ninth lens 190 may have at least one inflection point on at least one surface of an object-side surface and an image-side surface.

Meanwhile, each surface of the first lens 110 to ninth lens 190 may have an aspherical coefficient, as illustrated in Table 2. For example, both the object-side surface and the image-side surface of the first lens 110 to the ninth lens 190 may be aspherical.

TABLE 2

| | S1 | S2 | S3 | S4 | S5 | S6 |
|---|---|---|---|---|---|---|
| Conic Constant K | −0.2301 | 0.7975 | 0.7975 | 24.0737 | 87.8846 | 3.6593 |
| 4th Coefficient A | 0.0847 | 0.5651 | 0.5651 | 0.0040 | 0.0096 | 0.0028 |
| 6th Coefficient B | −0.5131 | −3.7734 | −3.7734 | 0.0029 | −0.0305 | 0.0343 |
| 8th Coefficient C | 2.0380 | 15.6952 | 15.6952 | −0.0473 | 0.1715 | −0.3250 |
| 10th Coefficient D | −5.4034 | −43.3755 | −43.3755 | 0.2189 | −0.6555 | 1.7198 |
| 12th Coefficient E | 9.9868 | 83.1223 | 83.1223 | −0.6005 | 1.6979 | −5.7831 |
| 14th Coefficient F | −13.2049 | −113.5051 | −113.5051 | 1.0968 | −3.0471 | 13.2293 |
| 16th Coefficient G | 12.6820 | 112.2657 | 112.2657 | −1.3976 | 3.8714 | −21.2837 |
| 18th Coefficient H | −8.9049 | −81.0264 | −81.0264 | 1.2679 | −3.5266 | 24.4878 |
| 20th Coefficient J | 4.5617 | 42.6054 | 42.6054 | −0.8232 | 2.3095 | −20.2261 |
| 22nd Coefficient L | −1.6833 | −16.1219 | −16.1219 | 0.3795 | −1.0773 | 11.8870 |
| 24th Coefficient M | 0.4352 | 4.2712 | 4.2712 | −0.1212 | 0.3491 | −4.8471 |
| 26th Coefficient N | −0.0748 | −0.7512 | −0.7512 | 0.0255 | −0.0746 | 1.3022 |
| 28th Coefficient O | 0.0077 | 0.0787 | 0.0787 | −0.0032 | 0.0095 | −0.2071 |
| 30th Coefficient P | −0.0004 | −0.0037 | −0.0037 | 0.0002 | −0.0005 | 0.0148 |

| | S7 | S8 | S9 | S10 | S11 | S12 |
|---|---|---|---|---|---|---|
| Conic Constant K | 7.3024 | −99.0000 | −96.3665 | 54.0219 | 13.2906 | −27.2470 |
| 4th Coefficient A | −0.0163 | −0.0279 | −0.0520 | −0.0451 | −0.0681 | −0.1050 |
| 6th Coefficient B | −0.0031 | 0.0338 | 0.0323 | 0.0388 | −0.0654 | 0.0541 |
| 8th Coefficient C | −0.0063 | −0.2112 | −0.1696 | −0.1685 | 0.4252 | −0.0339 |
| 10th Coefficient D | 0.2271 | 0.9823 | 0.6987 | 0.5574 | −1.1475 | 0.0208 |
| 12th Coefficient E | −1.3230 | −3.1573 | −2.1337 | −1.2764 | 1.9913 | −0.0099 |
| 14th Coefficient F | 4.1294 | 7.1307 | 4.6418 | 2.0214 | −2.4014 | 0.0020 |
| 16th Coefficient G | −8.1301 | −11.4617 | −7.1983 | −2.2640 | 2.0697 | 0.0011 |
| 18th Coefficient H | 10.7612 | 13.2323 | 8.0035 | 1.8210 | −1.2905 | −0.0011 |
| 20th Coefficient J | −9.8277 | −10.9856 | −6.3768 | −1.0560 | 0.5826 | 0.0005 |
| 22nd Coefficient L | 6.2127 | 6.4959 | 3.5997 | 0.4376 | −0.1883 | −0.0001 |
| 24th Coefficient M | −2.6704 | −2.6676 | −1.4011 | −0.1263 | 0.0424 | 0.0000 |
| 26th Coefficient N | 0.7446 | 0.7227 | 0.3564 | 0.0241 | −0.0063 | 0.0000 |
| 28th Coefficient O | −0.1213 | −0.1161 | −0.0531 | −0.0027 | 0.0006 | 0.0000 |
| 30th Coefficient P | 0.0088 | 0.0084 | 0.0035 | 0.0001 | 0.0000 | 0.0000 |

| | S13 | S14 | S15 | S16 | S17 | S18 |
|---|---|---|---|---|---|---|
| Conic Constant K | −14.8749 | −99.0000 | 2.6754 | −5.2020 | −5.2020 | −6.7082 |
| 4th Coefficient A | −0.0100 | 0.0066 | −0.1249 | 0.0066 | 0.0066 | −0.0608 |
| 6th Coefficient B | −0.0031 | −0.0028 | 0.0496 | −0.0620 | −0.0620 | 0.0176 |
| 8th Coefficient C | −0.0097 | −0.0058 | −0.0166 | 0.0500 | 0.0500 | −0.0020 |
| 10th Coefficient D | 0.0151 | 0.0058 | 0.0048 | −0.0227 | −0.0227 | −0.0007 |
| 12th Coefficient E | −0.0129 | −0.0033 | −0.0011 | 0.0067 | 0.0067 | 0.0004 |
| 14th Coefficient F | 0.0071 | 0.0013 | 0.0002 | −0.0014 | −0.0014 | −0.0001 |
| 16th Coefficient G | −0.0027 | −0.0004 | 0.0000 | 0.0002 | 0.0002 | 0.0000 |
| 18th Coefficient H | 0.0007 | 0.0001 | 0.0000 | 0.0000 | 0.0000 | 0.0000 |
| 20th Coefficient J | −0.0001 | 0.0000 | 0.0000 | 0.0000 | 0.0000 | 0.0000 |
| 22nd Coefficient L | 0.0000 | 0.0000 | 0.0000 | 0.0000 | 0.0000 | 0.0000 |
| 24th Coefficient M | 0.0000 | 0.0000 | 0.0000 | 0.0000 | 0.0000 | 0.0000 |
| 26th Coefficient N | 0.0000 | 0.0000 | 0.0000 | 0.0000 | 0.0000 | 0.0000 |
| 28th Coefficient O | 0.0000 | 0.0000 | 0.0000 | 0.0000 | 0.0000 | 0.0000 |
| 30th Coefficient P | 0.0000 | 0.0000 | 0.0000 | 0.0000 | 0.0000 | 0.0000 |

In addition, the optical imaging system configured as described above may have aberration characteristics as illustrated in FIG. 2.

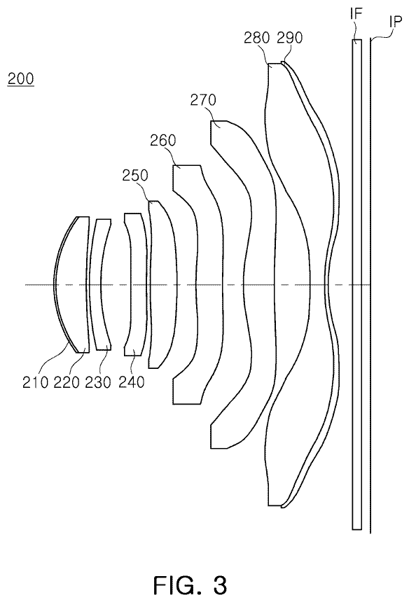

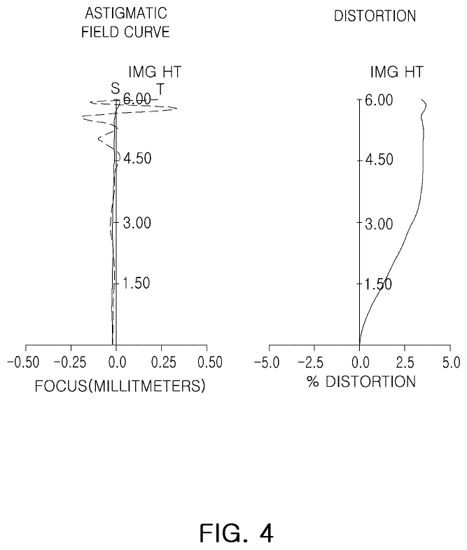

An optical imaging system 200 according to a second embodiment of the present disclosure will be described with reference to FIGS. 3 and 4.

The optical imaging system 200 according to the second embodiment of the present disclosure may include a first lens 210, a second lens 220, a third lens 230, a fourth lens 240, a fifth lens 250, a sixth lens 260, a seventh lens 270, an eighth lens 280, and a ninth lens 290, and may further include a filter IF and an image sensor.

The optical imaging system 200 according to the second embodiment of the present disclosure may form a focus on an imaging plane IP.

Lens characteristics of each lens (a radius of curvature, a thickness of a lens or a distance between lenses, a refractive index, and an Abbe number) are illustrated in Table 3.

TABLE 3

| Surface | | Curvature | Thickness or | Refractive | |
|---|---|---|---|---|---|
| No. | | Radius | Distance | Index | Abbe No. |
| S1 | 1st Lens | 2.850 | 0.058 | 1.650 | 21.0 |
| S2 | | 3.400 | 0.000 | | |
| S3 | 2nd Lens | 3.400 | 0.730 | 1.544 | 56.0 |
| S4 | | 18.385 | 0.100 | | |
| S5 | 3rd Lens | 7.728 | 0.240 | 1.669 | 19.4 |
| S6 | | 4.565 | 0.772 | | |
| S7 | 4th Lens | 178.335 | 0.364 | 1.669 | 19.4 |
| S8 | | 15.218 | 0.111 | | |
| S9 | 5th Lens | 42.555 | 0.636 | 1.544 | 56.0 |
| S10 | | −15.002 | 0.472 | | |
| S11 | 6th Lens | 8.583 | 0.646 | 1.566 | 37.4 |
| S12 | | 10.043 | 0.513 | | |
| S13 | 7th Lens | 4.986 | 0.757 | 1.544 | 56.0 |
| S14 | | −23.609 | 0.877 | | |
| S15 | 8th Lens | −31.621 | 0.361 | 1.534 | 55.8 |
| S16 | | 2.917 | 0.000 | | |
| S17 | 9th Lens | 2.917 | 0.083 | 1.650 | 21.0 |
| S18 | | 2.597 | 0.600 | | |
| S19 | Filter | Infinity | 0.210 | 1.517 | 64.2 |
| S20 | | Infinity | 0.199 | | |
| S21 | Imaging | Infinity | | | |
| | Plane | | | | |

In the second embodiment of the present disclosure, the first lens 210 may have positive refractive power, an object-side surface of the first lens 210 may be convex in the paraxial region, and an image-side surface of the first lens 210 may be concave in the paraxial region.

The second lens 220 may have positive refractive power, an object-side surface of the second lens 220 may be convex in the paraxial region, and an image-side surface of the second lens 220 may be concave in t paraxial region.

The first lens 210 and the second lens 220 may be in cemented form. For example, the image-side surface of the first lens 210 and the object-side surface of the second lens 220 may be cemented to each other.

The first lens 210 and the second lens 220 may be cemented to each other by using an adhesive.

The third lens 230 may have negative refractive power, an object-side surface of the third lens 230 may be convex in the paraxial region, and an image-side surface of the third lens 230 may be concave in the paraxial region.

The fourth lens 240 may have negative refractive power, an object-side surface of the fourth lens 240 may be convex in the paraxial region, and an image-side surface of the fourth lens 240 may be concave in the paraxial region.

The fifth lens 250 may have positive refractive power, and both an object-side surface and an image-side surface of the fifth lens 250 may be convex in the paraxial region.

The sixth lens 260 may have positive refractive power, an object-side surface of the sixth lens 260 may be convex in the paraxial region, and an image-side surface of the sixth lens 260 may be concave in the paraxial region.

The seventh lens 270 may have positive refractive power, and both an object-side surface and an image-side surface of the seventh lens 270 may be convex in the paraxial region.

The eighth lens 280 may have negative refractive power, and both an object-side surface and an image-side surface of the eighth lens 280 may be concave in the paraxial region.

The ninth lens 290 may have negative refractive power, an object-side surface of the ninth lens 290 may be convex in the paraxial region, and an image-side surface of the ninth lens 290 may be concave in the paraxial region.

The eighth lens 280 and the ninth lens 290 may be in cemented form. For example, the image-side surface of the eighth lens 280 and the object-side surface of the ninth lens 290 may be cemented to each other.

The eighth lens 280 and the ninth lens 290 may be cemented to each other by using an adhesive.

One or more of the seventh lens 270 to the ninth lens 290 may have at least one inflection point on at least one surface of an object-side surface and an image-side surface.

Meanwhile, each surface of the first lens 210 to the ninth lens 290 may have an aspherical coefficient, as illustrated in Table 4. For example, both the object-side surface and the image-side surface of the first lens 210 to the ninth lens 290 may be aspherical.

TABLE 4

| | S1 | S2 | S3 | S4 | S5 | S6 |
|---|---|---|---|---|---|---|
| Conic Constant K | −0.7753 | 1.9683 | 1.9683 | 22.0869 | −0.7499 | −0.7905 |
| 4th Coefficient A | 0.0696 | 0.4495 | 0.4495 | −0.0183 | −0.0321 | −0.0144 |
| 6th Coefficient B | −0.4094 | −3.1541 | −3.1541 | 0.0532 | 0.0672 | −0.0142 |
| 8th Coefficient C | 1.6011 | 13.2591 | 13.2591 | −0.1760 | −0.1865 | 0.2436 |
| 10th Coefficient D | −4.0970 | −36.2835 | −36.2835 | 0.5224 | 0.5154 | −1.0790 |
| 12th Coefficient E | 7.2326 | 68.1123 | 68.1123 | −1.1600 | −1.0893 | 2.9067 |
| 14th Coefficient F | −9.1100 | −90.8101 | −90.8101 | 1.8629 | 1.6723 | −5.2940 |
| 16th Coefficient G | 8.3555 | 87.8175 | 87.8175 | −2.1674 | −1.8601 | 6.8024 |
| 18th Coefficient H | −5.6330 | −62.2141 | −62.2141 | 1.8343 | 1.5038 | −6.2890 |
| 20th Coefficient J | 2.7891 | 32.2770 | 32.2770 | −1.1269 | −0.8816 | 4.2048 |
| 22nd Coefficient L | −1.0019 | −12.1183 | −12.1183 | 0.4965 | 0.3703 | −2.0159 |
| 24th Coefficient M | 0.2539 | 3.2034 | 3.2034 | −0.1527 | −0.1085 | 0.6758 |
| 26th Coefficient N | −0.0430 | −0.5652 | −0.5652 | 0.0311 | 0.0210 | −0.1505 |
| 28th Coefficient O | 0.0044 | 0.0597 | 0.0597 | −0.0038 | −0.0024 | 0.0200 |
| 30th Coefficient P | −0.0002 | −0.0029 | −0.0029 | 0.0002 | 0.0001 | −0.0012 |

| | S7 | S8 | S9 | S10 | S11 | S12 |
|---|---|---|---|---|---|---|
| Conic Constant K | −40.6841 | 20.5175 | −14.9127 | 35.7287 | −10.2079 | 3.2279 |
| 4th Coefficient A | −0.0245 | −0.0257 | −0.0039 | −0.0149 | −0.0228 | −0.0221 |
| 6th Coefficient B | −0.0545 | −0.0203 | −0.0249 | −0.0045 | −0.0090 | −0.0213 |
| 8th Coefficient C | 0.2232 | 0.0016 | 0.0309 | −0.0027 | 0.0079 | 0.0231 |
| 10th Coefficient D | −0.5836 | 0.1498 | 0.0119 | 0.0362 | 0.0077 | −0.0128 |
| 12th Coefficient E | 1.0380 | −0.4526 | −0.0918 | −0.0778 | −0.0211 | 0.0046 |
| 14th Coefficient F | −1.2907 | 0.7315 | 0.1470 | 0.0937 | 0.0218 | −0.0012 |
| 16th Coefficient G | 1.1224 | −0.7691 | −0.1369 | −0.0746 | −0.0141 | 0.0003 |
| 18th Coefficient H | −0.6657 | 0.5598 | 0.0853 | 0.0415 | 0.0064 | −0.0001 |
| 20th Coefficient J | 0.2491 | −0.2885 | −0.0371 | −0.0164 | −0.0021 | 0.0000 |
| 22nd Coefficient L | −0.0433 | 0.1052 | 0.0114 | 0.0046 | 0.0005 | 0.0000 |
| 24th Coefficient M | −0.0065 | −0.0266 | −0.0024 | −0.0009 | −0.0001 | 0.0000 |
| 26th Coefficient N | 0.0053 | 0.0044 | 0.0003 | 0.0001 | 0.0000 | 0.0000 |
| 28th Coefficient O | −0.0011 | −0.0004 | 0.0000 | 0.0000 | 0.0000 | 0.0000 |
| 30th Coefficient P | 0.0001 | 0.0000 | 0.0000 | 0.0000 | 0.0000 | 0.0000 |

| | S13 | S14 | S15 | S16 | S17 | S18 |
|---|---|---|---|---|---|---|
| Conic Constant K | −1.0306 | 33.5029 | 13.1378 | −1.2510 | −1.2510 | −1.2336 |
| 4th Coefficient A | 0.0137 | 0.0484 | −0.0328 | −0.0673 | −0.0673 | −0.0602 |
| 6th Coefficient B | −0.0201 | −0.0188 | −0.0044 | 0.0230 | 0.0230 | 0.0126 |
| 8th Coefficient C | 0.0047 | −0.0022 | 0.0049 | −0.0074 | −0.0074 | −0.0015 |
| 10th Coefficient D | 0.0012 | 0.0055 | −0.0015 | 0.0019 | 0.0019 | −0.0001 |
| 12th Coefficient E | −0.0011 | −0.0029 | 0.0003 | −0.0003 | −0.0003 | 0.0001 |
| 14th Coefficient F | 0.0002 | 0.0009 | 0.0000 | 0.0000 | 0.0000 | 0.0000 |
| 16th Coefficient G | 0.0000 | −0.0002 | 0.0000 | 0.0000 | 0.0000 | 0.0000 |
| 18th Coefficient H | 0.0000 | 0.0000 | 0.0000 | 0.0000 | 0.0000 | 0.0000 |
| 20th Coefficient J | 0.0000 | 0.0000 | 0.0000 | 0.0000 | 0.0000 | 0.0000 |
| 22nd Coefficient L | 0.0000 | 0.0000 | 0.0000 | 0.0000 | 0.0000 | 0.0000 |
| 24th Coefficient M | 0.0000 | 0.0000 | 0.0000 | 0.0000 | 0.0000 | 0.0000 |
| 26th Coefficient N | 0.0000 | 0.0000 | 0.0000 | 0.0000 | 0.0000 | 0.0000 |
| 28th Coefficient O | 0.0000 | 0.0000 | 0.0000 | 0.0000 | 0.0000 | 0.0000 |
| 30th Coefficient P | 0.0000 | 0.0000 | 0.0000 | 0.0000 | 0.0000 | 0.0000 |

In addition, the optical imaging system configured as described above may have aberration characteristics as illustrated in FIG. 4.

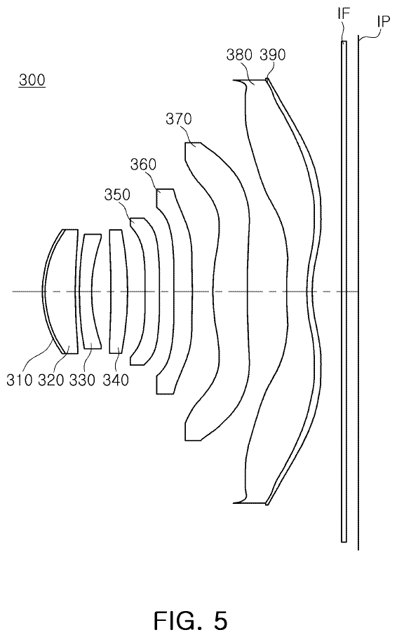

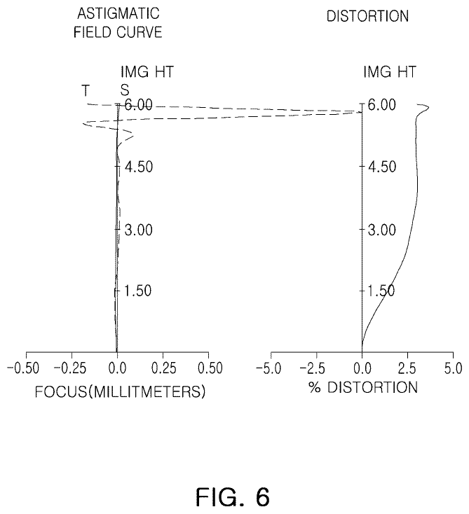

An optical imaging system 300 according to a third embodiment of the present disclosure will be described with reference to FIGS. 5 and 6.

The optical imaging system 300 according to the third embodiment of the present disclosure may include a first lens 310, a second lens 320, a third lens 330, a fourth lens 340, a fifth lens 350, a sixth lens 360, a seventh lens 370, an eighth lens 380, and a ninth lens 390, and may further include a filter IF and an image sensor.

The optical imaging system according to the third embodiment of the present disclosure may form a focus on an imaging plane IP.

Lens characteristics of each lens (a radius of curvature, a thickness of a lens or a distance between lenses, a refractive index, and an Abbe number) are illustrated in Table 5.

TABLE 5

| Surface | | Curvature | Thickness or | Refractive | |
|---|---|---|---|---|---|
| No. | | Radius | Distance | Index | Abbe No. |
| S1 | 1st Lens | 2.491 | 0.070 | 1.650 | 21.0 |
| S2 | | 2.900 | 0.000 | | |
| S3 | 2nd Lens | 2.900 | 0.709 | 1.544 | 56.0 |
| S4 | | 14.673 | 0.100 | | |
| S5 | 3rd Lens | 8.530 | 0.291 | 1.671 | 19.2 |
| S6 | | 4.175 | 0.442 | | |
| S7 | 4th Lens | 92.805 | 0.401 | 1.544 | 56.0 |
| S8 | | −16.417 | 0.419 | | |
| S9 | 5th Lens | −11.181 | 0.346 | 1.671 | 19.2 |
| S10 | | −54.321 | 0.323 | | |
| S11 | 6th Lens | 30.055 | 0.446 | 1.614 | 25.9 |
| S12 | | 15.032 | 0.484 | | |
| S13 | 7th Lens | 3.724 | 0.819 | 1.567 | 37.4 |
| S14 | | 16.250 | 0.933 | | |
| S15 | 8th Lens | 5.737 | 0.460 | 1.535 | 55.7 |
| S16 | | 2.625 | 0.000 | | |
| S17 | 9th Lens | 2.625 | 0.120 | 1.650 | 21.0 |
| S18 | | 2.092 | 0.700 | | |
| S19 | Filter | Infinity | 0.110 | 1.517 | 64.2 |
| S20 | | Infinity | 0.287 | | |
| S21 | Imaging | Infinity | | | |
| | Plane | | | | |

In the third embodiment of the present disclosure, the first lens 310 may have positive refractive power, an object-side surface of the first lens 310 may be convex in the paraxial region, and an image-side surface of the first lens 310 may be concave in the paraxial region.

The second lens 320 may have positive refractive power, an object-side surface of the second lens 320 may be convex in the paraxial region, and an image-side surface of the second lens 320 may be concave in the paraxial region.

The first lens 310 and the second lens 320 may be in cemented form. For example, the image-side surface of the first lens 310 and the object-side surface of the second lens 320 may be cemented to each other.

The first lens 310 and the second lens 320 may be cemented to each other by using an adhesive.

The third lens 330 may have negative refractive power, an object-side surface of the third lens 330 may be convex in the paraxial region, and an image-side surface of the third lens 330 may be concave in the paraxial region.

The fourth lens 340 may have positive refractive power, and both an object-side surface and an image-side surface of the fourth lens 340 may be convex in the paraxial region.

The fifth lens 350 may have negative refractive power, an object-side surface of the fifth lens 350 may be concave in the paraxial region, and an image-side surface of the fifth lens 350 may be convex in the paraxial region.

The sixth lens 360 may have negative refractive power, an object-side surface of the sixth lens 360 may be convex in the paraxial region, and an image-side surface of the sixth lens 360 may be concave in the paraxial region.

The seventh lens 370 may have positive refractive power, an object-side surface of the seventh lens 370 may be convex in the paraxial region, and an image-side surface of the seventh lens 370 may be concave in the paraxial region.

The eighth lens 380 may have negative refractive power, an object-side surface of the eighth lens 380 may be convex in the paraxial region, and an image-side surface of the eighth lens 380 may be concave in the paraxial region.

The ninth lens 390 may have negative refractive power, an object-side surface of the ninth lens 290 may be convex in the paraxial region, and an image-side surface of the ninth lens 390 may be concave in the paraxial region.

The eighth lens 380 and the ninth lens 390 may be in cemented form. For example, the image-side surface of the eighth lens 380 and the object-side surface of the ninth lens 390 may be cemented to each other.

The eighth lens 380 and the ninth lens 390 may be cemented to each other by using an adhesive.

One or more of the seventh lens 370 to the ninth lens 390 may have at least one inflection point on at least one surface of an object-side surface and an image-side surface.

Meanwhile, each surface of the first lens 310 to the ninth lens 390 may have an aspherical coefficient, as illustrated in Table 6. For example, both the object-side surface and the image-side surface of the first lens 310 to the ninth lens 390 may be aspherical.

TABLE 6

| | S1 | S2 | S3 | S4 | S5 | S6 |
|---|---|---|---|---|---|---|
| Conic Constant K | −0.4540 | −0.4213 | −0.4213 | −1.2772 | 3.9801 | 3.1759 |
| 4th Coefficient A | 0.0540 | 0.3445 | 0.3445 | −0.0140 | −0.0271 | −0.0172 |
| 6th Coefficient B | −0.3806 | −2.8612 | −2.8612 | 0.0468 | 0.0827 | 0.0294 |
| 8th Coefficient C | 1.9778 | 15.7064 | 15.7064 | −0.2781 | −0.4540 | −0.1119 |
| 10th Coefficient D | −6.9249 | −57.4359 | −57.4359 | 1.3975 | 2.2089 | 0.5087 |
| 12th Coefficient E | 16.8411 | 144.7686 | 144.7686 | −4.7210 | −7.6131 | −1.6524 |
| 14th Coefficient F | −29.1570 | −258.6342 | 258.6342 | 10.8391 | 18.4101 | 3.6097 |
| 16th Coefficient G | 36.5323 | 333.5840 | 333.5840 | −17.4390 | −31.6622 | −5.2713 |
| 18th Coefficient H | −33.3905 | −313.4363 | −313.4363 | 20.0601 | 39.1233 | 5.0470 |
| 20th Coefficient J | 22.2387 | 214.4384 | 214.4384 | −16.6193 | −34.7907 | −2.9193 |
| 22nd Coefficient L | −10.6653 | −105.5923 | −105.5923 | 9.8550 | 22.0550 | 0.6830 |
| 24th Coefficient M | 3.5846 | 36.4273 | 36.4273 | −4.0862 | −9.7195 | 0.2957 |
| 26th Coefficient N | −0.8008 | −8.3512 | −8.3512 | 1.1264 | 2.8288 | −0.2858 |
| 28th Coefficient O | 0.1068 | 1.1423 | 1.1423 | −0.1856 | −0.4888 | 0.0888 |
| 30th Coefficient P | −0.0064 | −0.0705 | −0.0705 | 0.0138 | 0.0380 | −0.0104 |

| | S7 | S8 | S9 | S10 | S11 | S12 |
|---|---|---|---|---|---|---|
| Conic Constant K | 99.0000 | 83.4444 | −35.5201 | 99.0000 | 99.0000 | −4.6432 |
| 4th Coefficient A | −0.0062 | −0.0179 | −0.0383 | −0.0376 | −0.0681 | −0.0938 |
| 6th Coefficient B | −0.1076 | 0.0268 | −0.0042 | 0.0219 | 0.0655 | 0.0668 |
| 8th Coefficient C | 0.7315 | −0.2041 | 0.0508 | −0.0255 | −0.0657 | −0.0573 |
| 10th Coefficient D | −3.1668 | 0.8641 | −0.2605 | −0.0125 | 0.0517 | 0.0469 |
| 12th Coefficient E | 9.2924 | −2.3498 | 0.6778 | 0.0712 | −0.0357 | −0.0333 |
| 14th Coefficient F | −19.1550 | 4.3382 | −1.1230 | −0.0960 | 0.0264 | 0.0202 |
| 16th Coefficient G | 28.3056 | −5.6170 | 1.2802 | 0.0663 | −0.0210 | −0.0100 |
| 18th Coefficient H | −30.2635 | 5.1915 | −1.0392 | −0.0198 | 0.0141 | 0.0038 |
| 20th Coefficient J | 23.4011 | −3.4424 | 0.6085 | −0.0052 | −0.0069 | −0.0011 |
| 22nd Coefficient L | −12.9366 | 1.6248 | −0.2566 | 0.0076 | 0.0023 | 0.0002 |
| 24th Coefficient M | 4.9773 | −0.5330 | 0.0765 | −0.0034 | −0.0005 | 0.0000 |
| 26th Coefficient N | −1.2643 | 0.1155 | −0.0155 | 0.0008 | 0.0001 | 0.0000 |
| 28th Coefficient O | 0.1903 | −0.0149 | 0.0019 | −0.0001 | 0.0000 | 0.0000 |
| 30th Coefficient P | −0.0128 | 0.0009 | −0.0001 | 0.0000 | 0.0000 | 0.0000 |
| | S13 | S14 | S15 | S16 | S17 | S18 |
| Conic Constant K | −15.0954 | −66.1805 | −31.1755 | −7.1542 | −7.1542 | −6.2730 |
| 4th Coefficient A | −0.0054 | 0.0006 | −0.0935 | −0.0017 | −0.0017 | −0.0441 |
| 6th Coefficient B | −0.0056 | 0.0013 | 0.0338 | −0.0390 | −0.0390 | 0.0096 |
| 8th Coefficient C | 0.0029 | −0.0030 | −0.0104 | 0.0289 | 0.0289 | −0.0004 |
| 10th Coefficient D | −0.0036 | 0.0002 | 0.0025 | −0.0116 | −0.0116 | −0.0005 |
| 12th Coefficient E | 0.0029 | 0.0008 | −0.0004 | 0.0030 | 0.0030 | 0.0002 |
| 14th Coefficient F | −0.0014 | −0.0005 | 0.0000 | −0.0005 | −0.0005 | 0.0000 |
| 16th Coefficient G | 0.0004 | 0.0002 | 0.0000 | 0.0001 | 0.0001 | 0.0000 |
| 18th Coefficient H | −0.0001 | 0.0000 | 0.0000 | 0.0000 | 0.0000 | 0.0000 |
| 20th Coefficient J | 0.0000 | 0.0000 | 0.0000 | 0.0000 | 0.0000 | 0.0000 |
| 22nd Coefficient L | 0.0000 | 0.0000 | 0.0000 | 0.0000 | 0.0000 | 0.0000 |
| 24th Coefficient M | 0.0000 | 0.0000 | 0.0000 | 0.0000 | 0.0000 | 0.0000 |
| 26th Coefficient N | 0.0000 | 0.0000 | 0.0000 | 0.0000 | 0.0000 | 0.0000 |
| 28th Coefficient O | 0.0000 | 0.0000 | 0.0000 | 0.0000 | 0.0000 | 0.0000 |
| 30th Coefficient P | 0.0000 | 0.0000 | 0.0000 | 0.0000 | 0.0000 | 0.0000 |

In addition, the optical imaging system configured as described above may have aberration characteristics as illustrated in FIG. 6.

TABLE 7

| | 1^{st} | 2^{nd} | 3^{rd} |
|---|---|---|---|
| | Embodiment | Embodiment | Embodiment |
| f | 6.2954 | 6.1381 | 6.3926 |
| f1 | 22.661 | 25.7306 | 25.1336 |
| f2 | 6.5517 | 7.5106 | 6.4779 |
| f3 | −12.9257 | −16.9952 | −12.3798 |
| f4 | 34.6904 | −24.5942 | 25.5665 |
| f5 | −41.1985 | 20.3939 | −20.8059 |
| f6 | −43.6343 | 89.3482 | −49.0634 |
| f7 | 8.2469 | 7.611 | 8.2671 |
| f8 | −12.5438 | −4.963 | −9.4994 |
| f9 | −9.3102 | −40.1205 | −17.1984 |
| f12 | 5.1180 | 5.8660 | 5.2082 |
| f89 | −5.3969 | −4.3876 | −6.1298 |
| EPD | 3.340 | 3.303 | 2.846 |
| IMG HT | 6.000 | 6.000 | 6.000 |
| FOV | 85.5 | 86.7 | 84.7 |

In Table 7, f is a total focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, f7 is a focal length of the seventh lens, f8 is a focal length of the eighth lens, and f9 is a focal length of the ninth lens. Moreover, f12 is a composite focal length of the first lens and the second lens, and f89 is a composite focal length of the eighth lens and the ninth lens.

In an optical imaging system according to an embodiment of the present disclosure, a size may be reduced while realizing high resolution.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens, a second lens, a third lens, a fourth lens, a fifth lens, a sixth lens, a seventh lens, an eighth lens, and a ninth lens, sequentially disposed from an object side,
wherein a composite focal length of the first lens and the second lens has a positive value,
wherein a composite focal length of the eighth lens and the ninth lens has a negative value,
wherein the eighth lens and the ninth lens are cemented to each other, and
wherein the optical imaging system satisfies the following conditional expression:
$$0.05 < CT 9 / CT 8 < 0.5 ,$$
where CT9 is a thickness on an optical axis of the ninth lens, and CT8 is a thickness on an optical axis of the eighth lens.

2. The optical imaging system of claim 1, wherein the following conditional expression is satisfied:
$$0 < \vert f 8 / v 8 - f 9 / v 9 \vert < 2 ,$$
where f8 is a focal length of the eighth lens, v8 is an Abbe number of the eighth lens, f9 is a focal length of the ninth lens, and v9 is an Abbe number of the ninth lens.

3. The optical imaging system of claim 1, wherein an image-side surface of the eighth lens and an object-side surface of the ninth lens are cemented to each other, and
wherein the image-side surface of the eighth lens and the object-side surface of the ninth lens each have an inflection point.

4. The optical imaging system of claim 1, wherein the following conditional expression is satisfied:
$$0.5 < a v e ( v 8 , v 9 ) / v 7 < 1.2 ,$$
where ave(v8, v9) is the average of an Abbe number of the eighth lens and an Abbe number of the ninth lens, and v7 is an Abbe number of the seventh lens.

5. The optical imaging system of claim 1, wherein the first lens and the second lens are cemented to each other.

6. The optical imaging system of claim 5, wherein the following conditional expression is satisfied:
$$0 < \vert f 1 / v 1 - f 2 / v 2 \vert < 2 ,$$
where f1 is a focal length of the first lens, v1 is an Abbe number of the first lens, f2 is a focal length of the second lens, and v2 is an Abbe number of the second lens.

7. The optical imaging system of claim 5, wherein the following conditional expression is satisfied:
$$0.05 < CT 1 / CT 2 < 0.3 ,$$
where CT1 is a thickness on an optical axis of the first lens, and CT2 is a thickness on an optical axis of the second lens.

8. The optical imaging system of claim 5, wherein the following conditional expression is satisfied:
$$1.7 < a v e ( v 1 , v 2 ) / v 3 < 2.1 ,$$
where ave(v1, v2) is the average of an Abbe number of the first lens and an Abbe number of the second lens, and v3 is an Abbe number of the third lens.

9. The optical imaging system of claim 5, wherein the following conditional expression is satisfied:
$$3 < f 1 / f 2 < 4.5 ,$$
where f1 is a focal length of the first lens, and f2 is a focal length of the second lens.

10. The optical imaging system of claim 1, wherein the following conditional expression is satisfied:
$$0.4 < TTL / ( 2 \times IMG HT ) < 0.65 ,$$
where TTL is a distance on an optical axis from an object-side surface of the first lens to an imaging plane, and IMG HT is half the diagonal length of the imaging plane.

11. The optical imaging system of claim 1, wherein the following conditional expression is satisfied:
$$0.7 < f 12 / f < 1 ,$$
where f12 is the composite focal length of the first lens and the second lens, and f is a total focal length of the optical imaging system.

12. The optical imaging system of claim 1, wherein the following conditional expression is satisfied:
$$- 3 < f 3 / f < 0 ,$$
where f3 is a focal length of the third lens, and f is a total focal length of the optical imaging system.

13. The optical imaging system of claim 1, wherein the following conditional expression is satisfied:
$$1.1 < f 7 / f < 1.4 ,$$
where f7 is a focal length of the seventh lens, and f is a total focal length of the optical imaging system.

14. The optical imaging system of claim 1, wherein the following conditional expression is satisfied:
$$- 1 < f 89 / f < - 0.5 ,$$
where f89 is the composite focal length of the eighth lens and the ninth lens, and f is a total focal length of the optical imaging system.

15. The optical imaging system of claim 1, wherein the seventh lens has positive refractive power, and the eighth lens and ninth lens each have negative refractive power.

16. The optical imaging system of claim 1, wherein the first lens and second lens each have positive refractive power, and
wherein the third lens has negative refractive power.

17. An optical imaging system comprising:
a first lens having positive refractive power, a second lens having positive refractive power, a third lens, a fourth lens, a fifth lens, a sixth lens, a seventh lens, an eighth lens having negative refractive power, and a ninth lens having negative refractive power, sequentially disposed from an object side,
wherein the first lens and the second lens are cemented to each other, and
wherein the eighth lens and the ninth lens are cemented to each other.

18. The optical imaging system of claim 17, wherein the image-side surface of the eighth lens and the object-side surface of the ninth lens each have an inflection point.

19. The optical imaging system of claim 17, wherein the following conditional expression is satisfied:
$$0 < \vert f 1 / v 1 - f 2 / v 2 \vert < 2 ,$$
where f1 is a focal length of the first lens, v1 is an Abbe number of the first lens, f2 is a focal length of the second lens, and v2 is an Abbe number of the second lens.
